(19) United States
(12) Patent Application Publication
(10) Pub. No.: US 2012/0291897 A1
(43) Pub. Date: Nov. 22, 2012

(54) AIR CONDITIONING VALVE FOR EASY EVAPORATOR MAINTENANCE

(76) Inventor: CHRISTIAN RIDAO, Miami, FL (US)

(21) Appl. No.: 13/111,017

(22) Filed: May 19, 2011

(51) Int. Cl. F15D 1/00; F16K 1/00

(52) U.S. Cl. 137/613; 251/318

(57) ABSTRACT

The present invention pertains to a valve assembly comprising a first flow valve operatively coupled to a first hollow connecting rod and a second flow valve operatively coupled to a second hollow connecting rod. The valve assembly provides a means for removing components from an HVAC with either minimal or no loss of coolant or pressure in the system.

### FIELD OF THE INVENTION

The present invention relates to the art of air-conditioning valves.

### STATEMENT REGARDING FEDERALLY-SPONSORED RESEARCH AND DEVELOPMENT

Not applicable.

### BACKGROUND OF THE INVENTION

In a typical “split” Heat Ventilation and Air Conditioning system “HVAC,” the condenser and the compressor are located in an outdoor unit; the evaporator is mounted in the air-handling unit, which is often a forced-air furnace. On the smaller “package systems,” all of the components are located in a single outdoor unit that may be located on the ground or on the roof.

A refrigerant, such as freon, circulates through copper tubing that runs between these components. This refrigerant receives and releases heat as it raises and lowers in temperature, changing from liquid to gas and then back to liquid. The refrigerant is especially cold when it begins to circulate through the indoor coil. As the air handler pushes warm air across the coil, the refrigerant absorbs so much heat from the air that it turns into vapor. As a vapor, it travels to a compressor that pressurizes it and moves it through the outdoor coil, which jettisons the heat. A fan also helps to dissipate the heat. The refrigerant then passes through an expansion device that converts it to a low-pressure, low-temperature liquid, which returns to the indoor coil, and so the cycle continues.

Evaporator coils, which are continually damp, provide one of the best places for mold to grow. In addition to the constant dampness, the supply side of the coil is in contact with warm, humid outside air, and the dirt that gets past filters contains the nutrients that mold requires to grow.

The buildup of dirt and soil in coils is very difficult to clean and typically requires a professional to be hired for thorough cleaning. Keeping the coils clean through frequent maintenance and appropriate treatments will result in potentially dramatic energy savings. A study completed by Pacific Gas & Electric indicates that the efficiency of a 10 ton package unit can be improved 16% simply by cleaning the evaporator and condenser coils.

A dirty coil must work harder and consume more energy to accomplish the cooling task. An air conditioning unit with dirty coils can consume 40% more energy than a unit with clean coils, and all the while, cooling may be reduced to a point where the unit is unable to properly cool your home.

Regular maintenance and cleaning is the solution to these issues. Regular cleaning will increase the life expectancy and efficiency of a unit. As expected, the most important components to maintain in any air conditioning system are the evaporator coil and the condenser coil. However, proper service and cleaning of both components is typically best left to be performed by an HVAC professional.

Homeowner maintenance on the indoor evaporator coil is an even more difficult proposition. Some indoor coils are housed in a cabinet which has doors on the front for access to the coil. Basic surface cleaning can be performed by the homeowner, but thorough cleaning of this coil typically must be done by a qualified technician. Other evaporator coils are built into the supply air plenum which makes access impossible without cutting into the sheet metal plenum.

Both the evaporator and the condenser are sealed; therefore, a professional service person typically must be called for almost any maintenance other than routine surface cleaning because of the cutting involved as well as the necessity for recharging the system once coolant is released from the system. Because of the aforementioned difficulties in cleaning and maintenance of HVAC systems, a design is needed that would enable a homeowner to be able to remove components from the system for proper cleaning and maintenance without the need for cutting and the further environmental impact of releasing freon and other coolant substances into the environment once components are detached from the overall system. A modular valve system would potentially solved these issues.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1 depicts at least one embodiment of the invention, namely a detailed view of a valve assembly.

FIG. 2 depicts at least one embodiment of the invention, namely a detailed view of a valve assembly.

FIG. 3 depicts at least one embodiment of the invention, namely a detailed view of a valve assembly in conjunction with its attachment to an HVAC.

FIG. 4 depicts at least one embodiment of the invention, namely a detailed view of a valve assembly in conjunction with its attachment to an HVAC.

FIG. 5 depicts at least one embodiment of the invention, namely a detailed view of a valve assembly in conjunction with its detachment from an HVAC.

FIG. 6 depicts at least one embodiment of the invention, namely a detailed view of a valve assembly.

FIG. 7 depicts at least one embodiment of the invention, namely an exploded view of a valve assembly.

FIG. 8 depicts at least one embodiment of the invention, namely a detailed view of a valve assembly.

FIG. 9 depicts at least one embodiment of the invention, namely a detailed view of a valve assembly.

FIG. 10 depicts at least one embodiment of the invention, namely a detailed view of a valve assembly in conjunction with its attachment to an HVAC.

FIG. 11 depicts at least one embodiment of the invention, namely a detailed view of a valve assembly in conjunction with its detachment from an HVAC.

FIG. 12 depicts at least one embodiment of the invention, namely a cross-sectional view of a valve assembly.

FIG. 13 depicts at least one embodiment of the invention, namely a cross-sectional view of a valve assembly.

FIG. 14 depicts at least one embodiment of the invention, namely a cross-sectional view of a valve assembly.

FIG. 15 depicts at least one embodiment of the invention, namely a detailed view of a valve assembly.

FIG. 16 depicts at least one embodiment of the invention, namely a detailed view of a valve assembly.

### DESCRIPTION OF THE INVENTION

The present invention depicts an inventive solution to the fore mentioned issues related to the cleaning and maintenance of HVAC units.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, or should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as only one of or “exactly one of,” or, when used in the claims, “consisting of,” will refer to the inclusion of exactly one element of a number or list of elements. In general, the term or as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

The present invention utilizes at least one valve assembly in order to make the cleaning and maintenance of an HVAC unit very cost effective and effortless, such that it can be performed by the average homeowner. Once the evaporator is disconnected from the HVAC, using the ingenious valve assembly, cleaning and servicing becomes very easy with minimal loss of coolant and pressure from the system. The valve assembly makes the evaporator accessible and removable.

As used herein, the terms “substance” and “substances” refer to gases or liquids. In particular embodiments of the present invention, the substance is a refrigerant, such as but not limited to freon. Such substances may exist in a gaseous and liquid form, depending on the pressures and/or temperature of the environment within the assemblies of the present invention, as well as within the assemblies of the devices with which the present invention interconnect.

In at least one embodiment, the present invention pertains to a valve assembly comprising a first flow valve and a first hollow connecting rod. The first flow valve is operatively coupled to the first hollow connecting rod to form a first unit. The valve assembly further comprises a second flow valve and a second hollow connecting rod. The second flow valve is operatively coupled to the second hollow connecting rod to form a second unit. In some embodiments, the valve assembly further comprises at least one hollow connecting bolt removably coupled between the first unit and the second unit. In some embodiments, either the first unit or the second unit also comprises at least one discharge valve.

In some embodiments, the first unit and the second unit may both contain at least one discharge valve. In other embodiments, only the first unit contains at least one discharge valve. In still other embodiments, only the second unit contains at least one discharge valve.

In some embodiments, the valve assembly is made of a metal. In such embodiments, the metal is selected from the group comprising iron, steel, aluminum, nickel, and copper. In other embodiments, the metal is selected from a combination of metals selected from the group comprising iron, steel, aluminum, nickel, and copper. In such embodiments, each individual component of the valve assembly may be made of the same metal, a different metal or combinations of metals. In some embodiments, certain individual components of the valve assembly are made of the same metal while other components of the valve assembly are made of a different metal. It would be understood by those skilled in the art that any metal capable of withstanding conditions and strains found in an HVAC (such as extreme cold and pressure) could be used.

In some embodiments, the first flow valve and the second flow valve (collectively referred herein as “flow valves”) are valves selected from the group comprising a butterfly valve, ball valve, gate valve, check valve and combinations thereof.

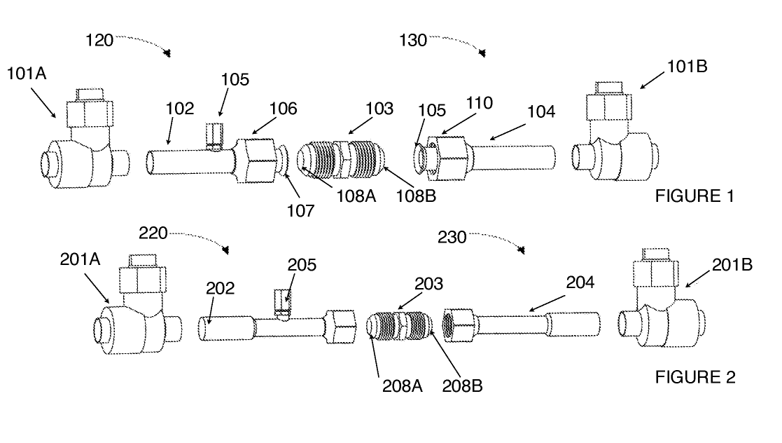

Referring now to the drawings in detail, in FIG. 1, a valve assembly is depicted, the assembly comprising a first flow valve 101A and a first hollow connecting rod 102. The first flow valve 101A is operatively coupled to the first hollow connecting rod 102 to form a first unit 120. The valve assembly further comprises a second flow valve 101B and a second hollow connecting rod 104. The second flow valve 101B is operatively coupled to the second hollow connecting rod 104 to form a second unit 130. In some embodiments, the valve assembly further comprises at least one hollow connecting bolt 103 removably coupled between the first unit 120 and the second unit 130. In some embodiments, either the first unit 120 or the second unit 130 also comprises at least one discharge valve 105. In some embodiments, the hollow connecting bolt 103 is removably coupled between the first 120 and second units 130 by way of a first fastening nut 106 and a second fastening nut 110 such that flow of substances is allowed between and through the first unit 120 and the second unit 130.

In some embodiments, the first hollow connecting rod 102 is flared at the end (as depicted in 107) where it (collectively the first unit 120) is removably coupled via the hollow connecting bolt 103 and the first fastening nut 106 with the second hollow connecting rod 104 (collectively the second unit 130). In other embodiments, the second hollow connecting rod 104 is flared at the end (as depicted in 109) where it (collectively the second unit 130) is removably coupled via the hollow connecting bolt 103 and the second fastening nut 110 with the first hollow connecting rod 102 (collectively the first unit 120). In still other embodiments, both the first hollow connecting rod 102 and the second hollow connecting rod 104 are flared at the ends (as depicted in 107 and 109) where they are removably coupled via the hollow connecting bolt 103 and the first fastening nut 106 and second fastening nut 110. In these embodiments, the hollow connecting bolt 103 is adapted (as depicted in 108A and 108B) to removably interconnect with the first fastening nut 106 and the second fastening nut 110. In some embodiments, the hollow connecting bolt 103 and the first fastening nut 106 and the second fastening nut 110 are threaded so that interconnection occurs by screwing the nuts onto the bolt.

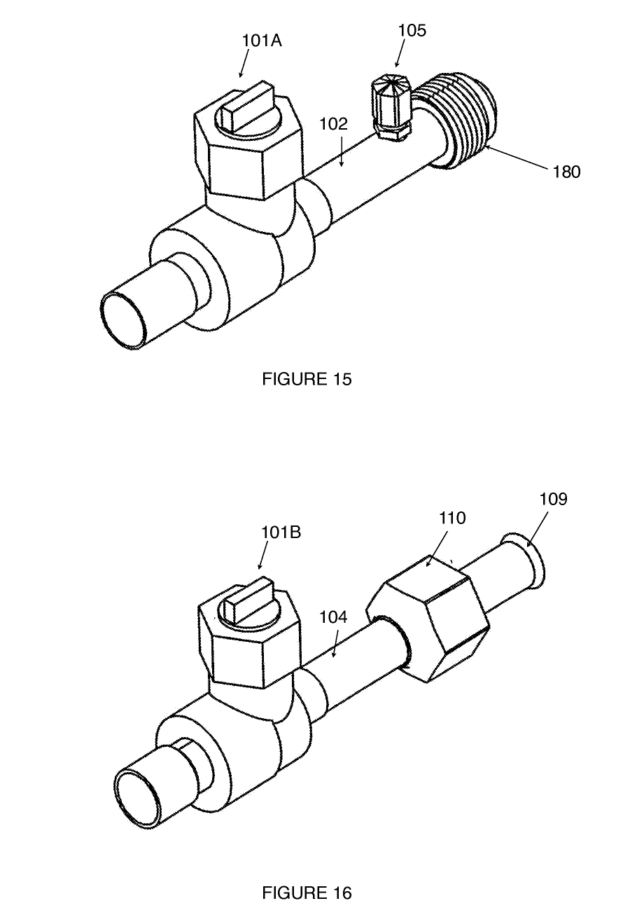

FIG. 16 shows a more detailed view of the embodiment depicted in FIG. 1 wherein the second hollow connecting rod 104 is flared at the end (as depicted in 109) with the second fastening nut 110 being movably positioned onto the second hollow connecting rod 104 whereby it can be positioned and threaded onto the hollow connecting bolt 103. In other embodiments, as shown in FIG. 15, the first hollow connecting rod 102 is threaded at the end 180 whereby it is adapted to removably couple with the second fastening nut 110 (as shown in FIG. 16). The hollow connecting bolt 103 would not be needed in such embodiments. As would be understood by those skilled in the art, the threaded end 180 could be included on the second hollow connecting rod 104 and removably coupled to the first fastening nut 106, again making the hollow connecting bolt 103 unnecessary.

Referring to FIG. 2, an embodiment of a valve assembly is depicted, the assembly comprising a first flow valve 201A and a first hollow connecting rod 202. The first flow valve 201A is operatively coupled to the first hollow connecting rod 202 to form a first unit 220. The valve assembly further comprises a second flow valve 201B and a second hollow connecting rod 204. The second flow valve 201B is operatively coupled to the second hollow connecting rod 204 to form a second unit 230. In some embodiments, the valve assembly further comprises at least one hollow connecting bolt 203 removably coupled between the first unit 220 and the second unit 230. In some embodiments, either the first unit 220 or the second unit 230 also comprises at least one discharge valve 205. In some embodiments, the hollow connecting bolt 203 is removably coupled between the first 220 and second units 230 such that flow of substances is allowed between and through the first unit and the second unit. In such an embodiment, the first hollow connecting rod 202 and the second hollow connecting rod 204 are adapted such that each rod is removably connected with the hollow connecting bolt 203. In some embodiments, the first hollow connecting rod 202 and the second hollow connecting rod 204 removably attach with the hollow connecting bolt 203 directly, without additional components. In some embodiments, the hollow connecting bolt 203 and the first first hollow connecting rod 202 and the second hollow connecting rod 204 are threaded so that interconnection occurs by screwing the ends of the connecting rods onto the bolt.

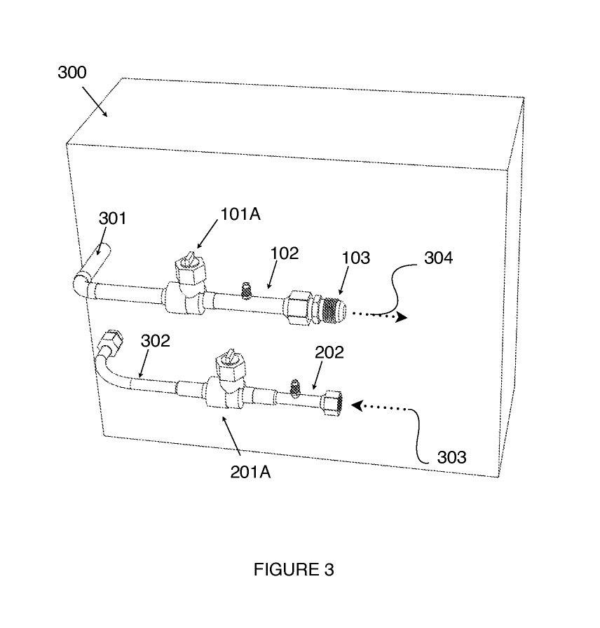

In at least one embodiment of the present invention, the valve assembly comprises two mirror valve assemblies, namely FIG. 1 and FIG. 2. In some embodiments, and referring now to FIG. 3, the FIG. 1 assembly is adapted for use in HVAC systems and regulates the substances going out 304 of the evaporator 300 and the FIG. 2 assembly regulates the substances going into 303 the evaporator 300 from an outside condenser unit. The FIG. 1 assembly is coupled to the evaporator 300 through line 301 where gas is re-released at low temperature and low pressure to the compressor that later gets cooled by the condensing coil outside. Similarly the FIG. 2 assembly is coupled to the evaporator 300 through line 302.

In some embodiments, the at least one flow valve 101A, 101B, 201A, 201B, may be magnetic, electric or electromechanical. Other types of valve that can be used for the same purpose and for the same result are butterfly valve, ball valve, gate valve, check valve and any combination thereof. In some embodiments, the valve assembly may further comprise at least one electro magnetic coil, whereby the at least one magnetic coil provides a magnetic field within or around the at least one flow valve 101.

In at least one embodiment, the present invention pertains to a valve assembly comprising at least one discharge valve 105, 205. The said discharge valve 105, 205 can be placed very close to the flow valve 101A, 101B, 201A, 201B. The purpose of the discharge valve 105, 205 is to release any pressure from the pipes in order to release the hollow connecting bolt 103 and 203, such as when a repair or maintenance is required for components of the HVAC.

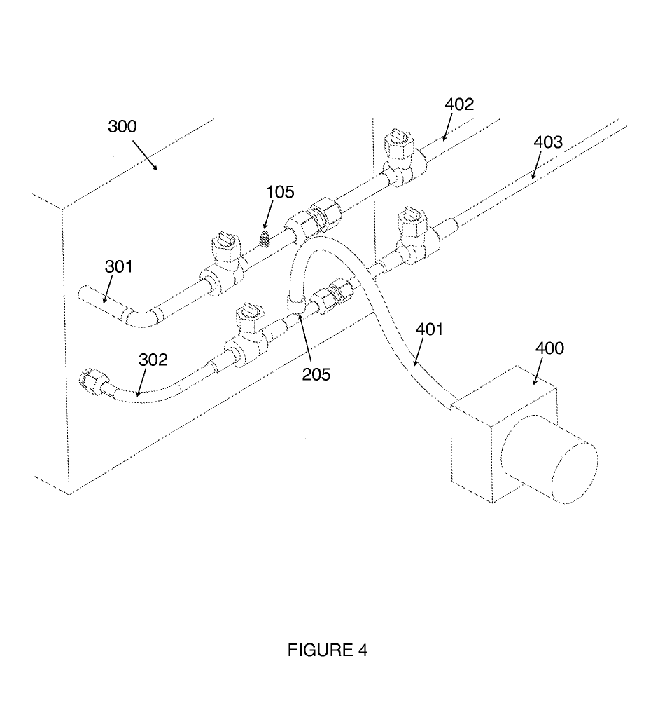

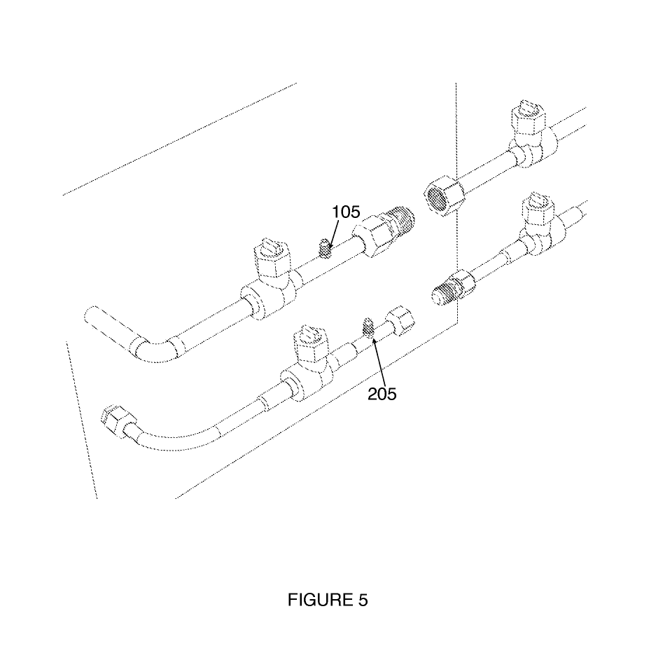

Referring to FIG. 4, a vacuum pump 400 is connected via a hose 401 to the discharge valve 105 or 205 and is used to release the pressure in the pipes before opening the valve assembly, as shown in FIG. 5. FIG. 5 depicts the valve assemblies after being opened with the first unit 120, 220 and the second unit 130, 230 being separated at the points where the hollow connecting bolts 103 and 203 interconnect the units. The position and size of the valve assembly may vary, and a person skilled in the art would understand the correct positioning of the discharge valves 105, 205 in close proximity to the flow valve. The dimensions of the valve assembly may also vary depending on the HVAC system.

The maintenance sequence of a home HVAC using the inventive valve assemblies of FIG. 1 and FIG. 2 are as follows: First, close flow valves 101A, 101B, 201A, 201B. Next, using the discharge valve 105 and 205, discharge the substance, e.g., freon, left between flow valves 101A, 101B, 201A, 201B by using a pump 400 or alternatively releasing by engaging the discharge valve 105 and 205 by other means. Next, using a wrench or other similar means, release either of the first fastening nut 106 and the second fastening nut 110, or by holding and/or releasing the hollow connecting bolt 103, 203 with a wrench or similar means. Next, remove the bolts that hold the evaporator 300 in place and dislodge the evaporator from the HVAC unit. Next, perform maintenance or repair on evaporator 300 or other component of the HVAC. Next, reinstall the evaporator 300 in the HVAC unit by reconnecting the previously unconnected connecting bolts and/or fastening nuts. Finally, the flow valves 101A, 101B, 201A, 201B are opened to return pressure and flow to the entire HVAC system with little loss in substance or pressure.

In some embodiments, the flow valves 101A, 101B, 201A, 201B are rotating valves. In some embodiments, upper ball bearings are utilized to aid in rotation of the flow valves 101A, 101B, 201A, 201B. In some embodiments, lower ball bearings are utilized to aid in rotation of the flow valves 101A, 101B, 201A, 201B.

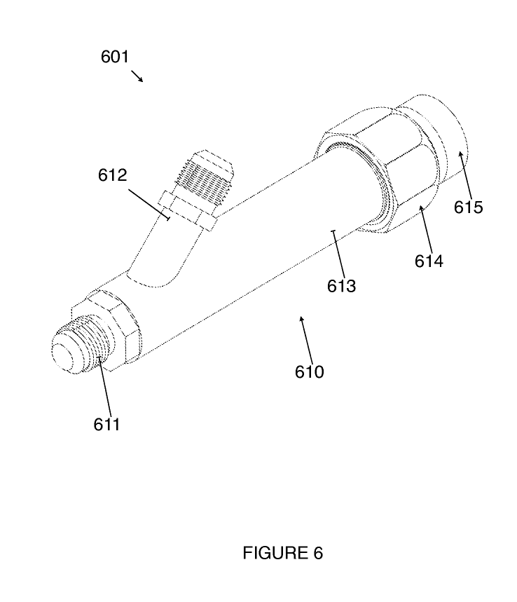

In another embodiment of the invention herein, as shown in FIG. 6 the valve assembly comprises a compact valve assembly 601 that eliminates the need for release valves, such as in 105 and 205. The compact valve assembly 601 comprises a hollow pipe body 610, comprising a first coupling stem 611, a second coupling stem 612 and a plunger stem 613; and a plunger (inside of the plunger stem 613), wherein said plunger is slideably and operatively disposed within said plunger stem 613, whereby extension of the plunger into the plunger stem 613 restricts material flow through the first coupling stem 611 and the second coupling stem 612 and whereby retraction of the plunger allows material flow through the first coupling stem 611 and the second coupling stem 612. Material flow means gases or fluids such as hydrochlorofluorocarbons, CFC, HFC, and HCFC including R12, R22, R404a, R 134a FR4, FREON, R-407C or any combination thereof.

In some embodiments, the plunger stem 613 further comprises an endcap 614. The endcap 614 is removably attached to the end distal to the first coupling stem 611 and second coupling stem 612.

In some embodiments, the plunger stem 613 also comprises a hand crank 615 that is operatively connected to the plunger. The endcap 614 is designed such that at least a portion of the plunger extends therethrough to operatively attach to the hand crank 615.

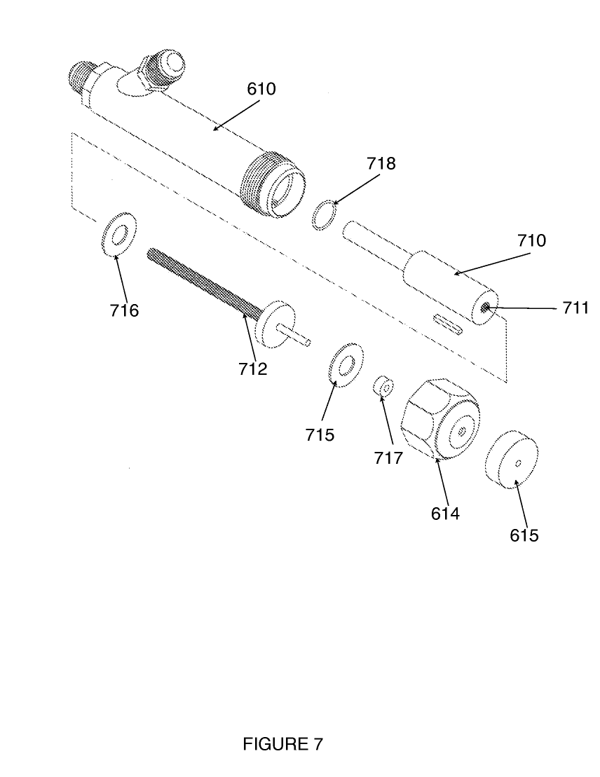

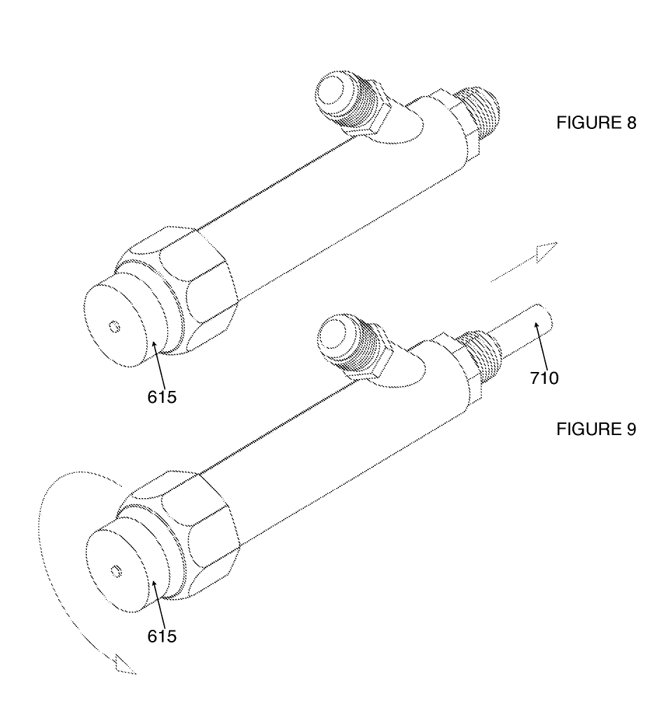

As shown in FIG. 7, an exploded view of the compact valve assembly shows the plunger 710 contained within the hollow pipe body 610. The plunger 710 further comprises a threaded bore 711 therethrough. The threaded bore 711 is operative with a threaded insert 712. The threaded insert 712 is threaded into the threaded bore 711 such that rotation of the hand crank 615 extends or retracts the plunger 710. As shown, in some embodiments, the assembly may further comprise one or more washers 715, 716, one or more spacers 717, and one or more sealing rings 718 to aid in securing components and providing a seal for pressure and substances within the valve. The final assembly of the compact valve results in the hand crank 615 being operatively secured to the end of the threaded insert 712 such that the crank can rotate the insert when manually rotated, resulting in the plunger 710 being extended or refracted, as shown in FIG. 8 and FIG. 9.

As shown in FIG. 8, in some embodiments, rotation of the hand crank 615 results in refraction of the plunger 710. As shown in FIG. 9, in other embodiments, rotation of the hand crank 615 in the opposite direction as in FIG. 8, results in extension of the plunger 710. Extension of the plunger into the plunger stem 613 restricts material flow through the first coupling stem 611 and the second coupling stem 612, whereas retraction of the plunger allows material flow through the first coupling stem 611 and the second coupling stem 612.

In some embodiments, the plunger 710 extends beyond the plunger stem 613 (as depicted in FIG. 9). Such design allows for the plunger 710 to force substance and pressure beyond the end of the valve assembly into pipes connected to the assembly. Functionally, this allows for a flow valve to be positioned on a connecting pipe immediately adjacent to the end of the fully extended plunger 710 within the connecting pipe, resulting in the ability to restrict flow with a flow valve while the plunger 710 is fully extended to allow for removal of components of an HVAC without pressure or substance loss from the overall system.

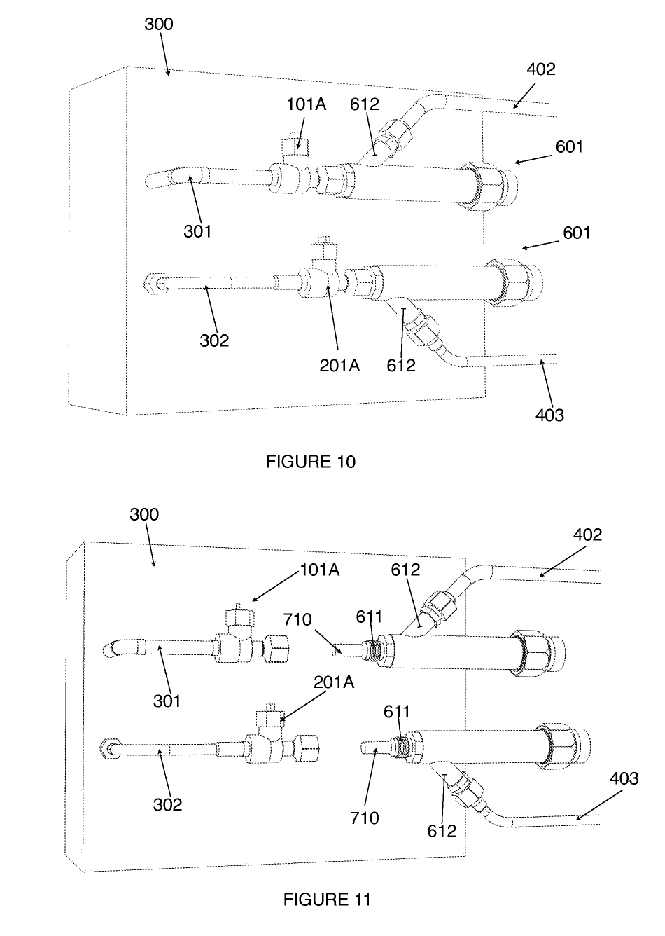

As shown in FIG. 10 and FIG. 11, in some embodiments, the flow valve 101A, 201A may be positioned in the HVAC system on the lines (i.e. pipes) 301, 302 to the evaporator 300 such that the first coupling stem 611 is removably attached to the lines 301, 302 such that the extended plunger 710 abuts the flow valve 101A, 201A in its “closed” position inside the line 301, 302. The remaining coupling stem (i.e. the second coupling stem 612) attaches to another component line of the HVAC, such as the lines to the condensor unit 402, 403. It would be understood by those skilled in the art that the compact valve could be in the reverse orientation with the first coupling stem 611 attaching to the lines to the condensor unit 402, 403 and the second coupling stem 612 attaching to the evaporator lines 301, 302.

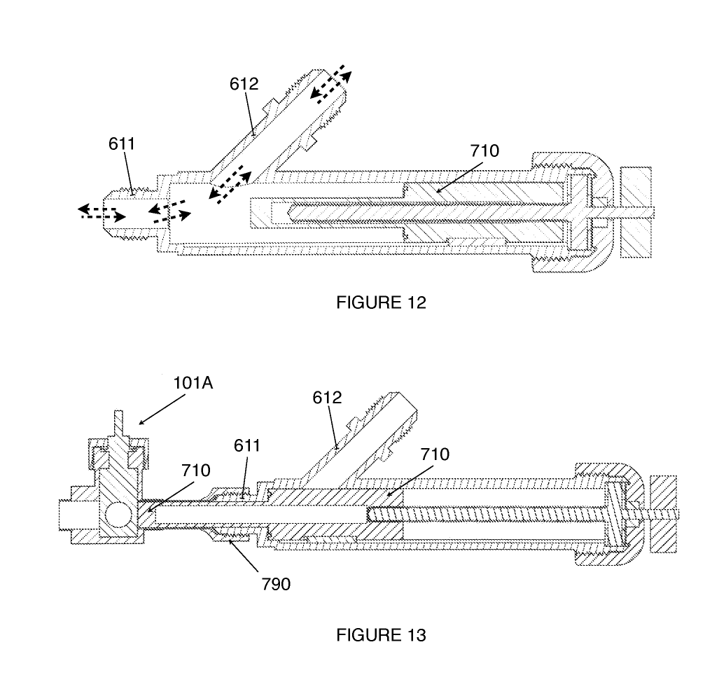

As shown in FIG. 12, a cross-sectional view of an embodiment of the present invention depicts the plunger 710 of the compact valve in the retracted position. As shown, the first coupling stem 611 and the second coupling stem 612 are unobstructed by the plunger 710, such that substance may flow freely through the stems.

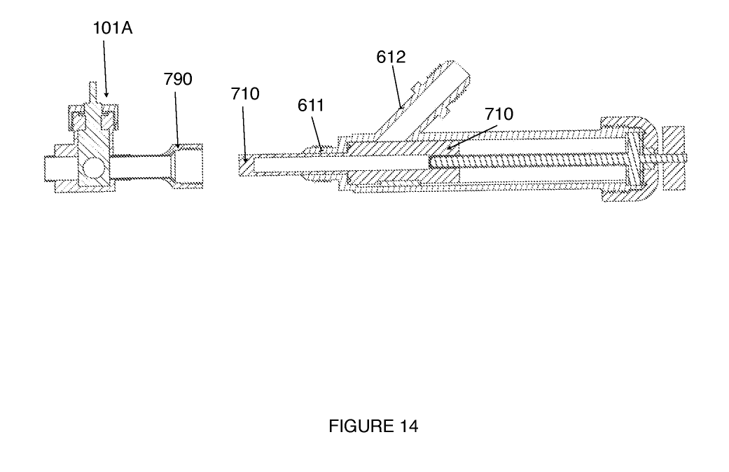

As shown in FIG. 13 and FIG. 14, a cross-sectional view of an embodiment of the present invention depicts the plunger 710 of the compact valve in the extended position. As shown, the first coupling stem 611 and the second coupling stem 612 are obstructed by the plunger 710, such that substance may not flow freely through the stems. FIG. 14 shows the first coupling stem 611 unattached from the line to/from the evaporator or the condensor. In some embodiments, and as shown in FIG. 13 and FIG. 14, the line comprises a line connecting nut 790 to allow for removable coupling with either the first coupling stem 611 or the second coupling stem 612.

In some embodiments, the compact valve assembly is made of a metal. In such embodiments, the metal is selected from the group comprising iron, steel, aluminum, nickel, and copper. In other embodiments, the metal is selected from a combination of metals selected from the group comprising iron, steel, aluminum, nickel, and copper. In such embodiments, each individual component of the compact valve assembly may be made of the same metal, a different metal or combinations of metals. In some embodiments, certain individual components of the compact valve assembly are made of the same metal while other components of the compact valve assembly are made of a different metal. It would be understood by those skilled in the art that any metal capable of withstanding conditions and strains found in an HVAC (such as extreme cold and pressure) could be used.

It is to be appreciated that the Detailed Description section, and not the Abstract section, is intended to be used to interpret the claims. The Abstract section may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A valve assembly, comprising:
a first flow valve and a first hollow connecting rod, wherein said first flow valve is operatively coupled to said first hollow connecting rod to form a first unit;
a second flow valve and a second hollow connecting rod, wherein said second flow valve is operatively coupled to said second hollow connecting rod to form a second unit; and
at least one hollow connecting bolt, wherein the connecting bolt is removably coupled between said first unit and said second unit, wherein either said first unit or said second unit further comprises at least one discharge valve.

2. The valve assembly of claim 1, wherein both said first unit and said second unit further comprise said at least one discharge valve.

3. The valve assembly of claim 1, wherein the valve assembly is made of a metal selected from the group comprising iron, steel, aluminum, nickel, copper, and combinations thereof.

4. The valve assembly of claim 1, wherein the first flow valve is a valve selected from the group comprising a butterfly valve, ball valve, gate valve, and check valve.

5. The valve assembly of claim 1, wherein the second flow valve is a valve selected from the group comprising a butterfly valve, ball valve, gate valve, and check valve.

6. A valve assembly, comprising:
a hollow pipe body, comprising a first coupling stem, a second coupling stem and a plunger stem; and
a plunger, wherein said plunger is slideably and operatively disposed within said plunger stem, whereby extension of said plunger into said plunger stem restricts material flow through said first coupling stem and said second coupling stem and whereby retraction of said plunger allows material flow through said first coupling stem and said second coupling stem.

7. The valve assembly of claim 6, wherein the plunger comprises a threaded bore therethrough.

8. The valve assembly of claim 7, further comprising a threaded insert comprising a hand crank, whereby rotation of said hand crank extends or retracts said plunger by way of threaded insert.

9. The valve assembly of claim 6, further comprising a flow valve operatively coupled to said first coupling stem.

10. The valve assembly of claim 6, further comprising a flow valve operatively coupled to said second coupling stem.

11. The valve assembly of claim 6, wherein the valve assembly is made of a metal selected from the group comprising iron, steel, aluminum, nickel, copper, and combinations thereof.

12. A valve assembly, comprising:
a hollow pipe body, comprising a first coupling stem, a second coupling stem and a plunger stem; and
a plunger comprising a threaded bore therethrough and a threaded insert therein, wherein said plunger is slideably and operatively disposed within said plunger stem, whereby extension of said plunger into said plunger stem by turning said hand crank restricts material flow through said first coupling stem and said second coupling stem and whereby retraction of said plunger by turning said hand crank allows material flow through said first coupling stem and said second coupling stem.

13. The valve assembly of claim 12, further comprising a flow valve operatively coupled to said first coupling stem.

14. The valve assembly of claim 12, further comprising a flow valve operatively coupled to said second coupling stem.

15. The valve assembly of claim 12, wherein the valve assembly is made of a metal selected from the group comprising iron, steel, aluminum, nickel, copper, and combinations thereof.

16. The valve assembly of claim 12, wherein the material flow is selected from the group consisting of hydrochlorofluorocarbons, CFC, HFC, HCFC, R12, R22, R404a , R 134a FR4, FREON, R-407C, and combinations thereof.

17. A air-conditioning cleaning valve comprising:
a first flow valve and a first hollow connecting rod, wherein said first flow valve is operatively coupled to said first hollow connecting rod to form a first unit; and
a second flow valve and a second hollow connecting rod, wherein said second flow valve is operatively coupled to said second hollow connecting rod to form a second unit; wherein both said first unit and said second unit further comprise said at least one discharge valve.

18. The valve assembly of claim 17, wherein the valve assembly is made of a metal selected from the group comprising iron, steel, aluminum, nickel, copper, and combinations thereof.

19. The valve assembly of claim 17, wherein the material flow is selected from the group consisting of hydrochlorofluorocarbons, CFC, HFC, HCFC, R12, R22, R404a , R 134a FR4, FREON, R-407C, and combinations thereof.
